(19) United States
(12) Patent Application Publication
(10) Pub. No.: US 2011/0282764 A1
(43) Pub. Date: Nov. 17, 2011

(54) VIRTUAL PARTIES AND PACKS

(75) Inventors: Karl Joseph Borst, Toronto (CA); Michael Kwant, Scarborough (CA); Jessica Boyd, Etobicoke (CA)

(73) Assignee: GANZ, Woodbridge (CA)

(21) Appl. No.: 13/105,472

(22) Filed: May 11, 2011

Related U.S. Application Data
(60) Provisional application No. 61/333,434, filed on May 11, 2010.

(51) Int. Cl. G06Q 30/00

(52) U.S. Cl. 705/27.1

(57) ABSTRACT

A party pack is purchased from an electronic store that includes everything necessary to have a party including games, prizes, food items, an invitation template, and prizes for the party recipients.

This application claims priority from provisional application No. 61/333,434, filed May 11, 2010, the entire contents of which are herewith incorporated by reference.

### BACKGROUND

A graphical chat room and/or virtual world can be hosted on a website in which users can control avatars to participate in activities and interact with other users' avatars. One such website including a graphical chat room and/or a virtual world is described in U.S. Pat. No. 7,677,948 to Ganz and in U.S. Pat. No. 6,910,186 to Kim, the contents of which are incorporated by reference in their entirety herein.

### SUMMARY

According to an aspect of the present invention a computerized system provides graphical representations of chat rooms in which multiple avatars or virtual pets can communicate and otherwise interact. A user can host a virtual party by reserving or renting a special chat room (hereinafter “party room”) on the system and invite a number of guests to attend the virtual party in the party room at a designated time.

According to one embodiment, there is a purchasing by selling to a first user, on an electronic store hosted by a server computer system, a virtual party package, which has multiple items therein, said virtual party package including all of the party favors to be given to party guest users, multiplayer games to be played by the party guest users, food for the virtual party to be consumed by party guest users, and an invitation template routine, operative for inviting a specified number of party guest users to the virtual party; responsive to said purchasing, selling said virtual party package, with adding all of said multiple items being added as a single package to a user's inventory of items maintained by said server computer system, where said inventory of items includes other virtual items owned by the user prior to said virtual party package being added; responsive to selecting receiving a selection of said virtual party package from said inventory of items, the server computer system providing a user interface screen which controls, via a user interaction, selecting each of a plurality of games to be played during a party, each of the plurality of games being selectable from one of a plurality of different games, and which controls the user selecting items to be given to party attendees as gifts for attending the party, where said items to be given to said party attendees are selected from a number of items, and which controls a template for inviting party attendees, including a form for said inviting, a time for the party, and selection of party guest users to attend the virtual party.

### BRIEF DESCRIPTION OF THE DRAWINGS

In the Drawings:

FIG. 1 shows the party pack section that is added to the store;

FIG. 2 shows specific party packs;

FIG. 3 shows party packs being added to the dock;

FIGS. 4 and 5 show contents of party packs;

FIG. 6 shows specific games for the party pack;

FIG. 7 shows loot bag prizes;

FIGS. 8-11 show invitation templates;

FIG. 12 shows the party widget;

FIG. 13 shows the invitation announcement;

FIG. 14 shows the status of invitations;

FIGS. 15A and 15B show party countdowns;

FIGS. 16 and 17 show party activities.

### DETAILED DESCRIPTION

The computerized system of embodiments may host a virtual world as described in U.S. Pat. No. 7,677,948. Each virtual pet may be provided with its own virtual room (hereinafter “pet's room”) which can serve, among other things, as a kind of private chat room. The user can host a virtual house party by inviting a number of guests to attend the virtual house party in the pet's room at a designated time.

According to another aspect of the invention, the system may limit the number of invitations for a specific party, for example, to eight guests according to an embodiment.

According to a further aspect of the invention, the host may purchase a virtual party package (with real or virtual currency), which contains virtual items, such as party favors and games, to be distributed to guests and/or used during the virtual party. For example, the host may purchase a house party packs that allows the host to create his/her own parties within the pet's room. The system may require that the host be present for the party to occur in the pet's room. As another example, a host may purchase a party room pack that allows the host to create a party within a rented chat room that is pre-designed and where the rented chat room does not belong to the host or the pet. The rented chat room may be a room as described in U.S. Pat. No. 7,677,948 or U.S. Pat. No. 6,910,186, or any other known chat room that includes virtual pets or avatars. With the party room pack, the system may allow a party to occur even if the host is not present.

According to various additional aspects of the invention:
Any purchase of a party pack will provide a loot bag to each guest. Each guest and the host must “grab” or claim the loot bag during the last five minutes of the party. The claimed loot bag is part of a guest's dock, and must be dragged into their own virtual room to claim the prizes within the loot bag. Unclaimed loot prizes will be returned to the host's dock at the end of the party. Hosts also have the option of dropping one or more of their own items in each of eight or nine loot bags to be randomly distributed to each of the guests.
Visitors to a social networking page of a host will see that a party event is taking place. If the host allows it, other users can click a “Can I come” button to ask the user if they can be invited to the party.
The host and the guests play a different game every five minutes. During the purchase of the party, the host will select the multiplayer games to be played.
The multiplayer games award prizes such as jellybeans for use with the Jellybean Challenge, virtual cash, or random virtual prizes from a loot bag.
The guests and the host play a series of games during the party, so long as at least three users are playing. Otherwise, no prizes are awarded for the game and the game cannot be started.
The system may prevent a host or guest from double booking themselves for the same time slot with more than one party.

According to one embodiment, a system describes:
Providing a system that allows a virtual character to be registered by a host, where the host purchases the right to invite a plurality of guests to a virtual room for a limited time period with the incentive of allowing the guests to participate in multiplayer games and providing virtual items to each of the guests, and including providing an application for the host to select their own virtual items to be distributed to the guests randomly as gifts in exchange for attending the event.
Providing a system that allows a virtual character to be registered by a host, where the host purchases the right to invite a plurality of guests to a virtual room for a limited time period with the incentive of allowing the guests to participate in multiplayer games and providing virtual items to each of the guests, where the party still occurs even when the host is not present.

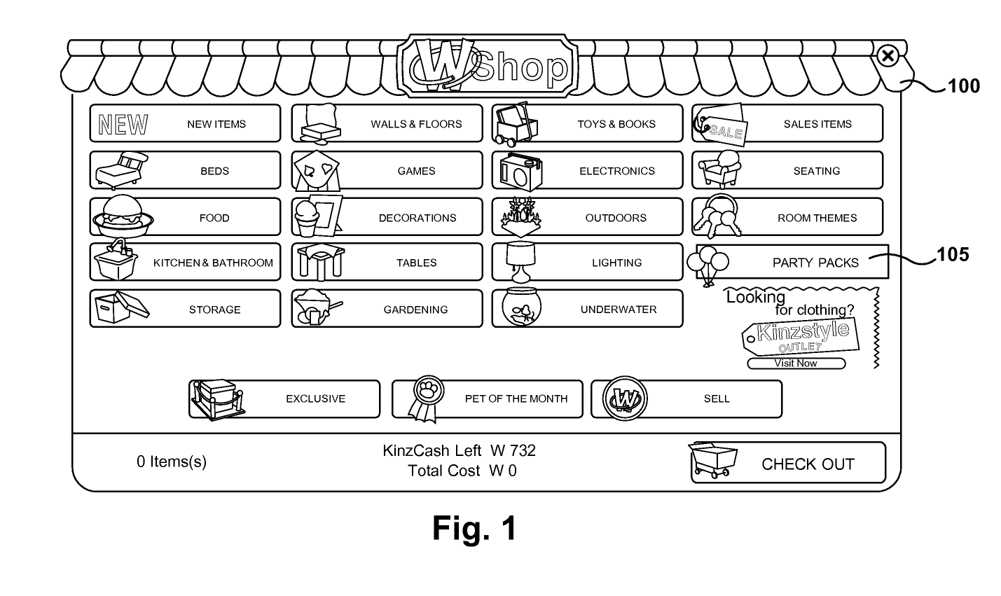

FIG. 1 illustrates how a new “Party Packs” section is added to an electronic shop, e.g, the WShop, where users can buy “House Party Packs” or “Party Room Packs.” The house party packs are each a single pack of items that have all the items needed to allow users to create their own parties within their pet's room. Users can invite up to eight guests to attend their house party in one embodiment. Based on the items in the pack, users can set up everything needed for their house party, e.g., by choosing four games to play at their party, decide whether or not to add extra prizes to their loot bags, invite guests, choose a date, time and color zone for their party.

Once selected, the pre-configured house party pack is added into a virtual room associated with a virtual item (e.g. a virtual pet). The added house party pack can be added, for example, by dragging and dropping a house party pack into a user's virtual room, or one of the user's pet's room.

Party Room Packs allow users to create their own parties within a system owned party room by “renting” a system owned party room. According to one embodiment, users are allowed to “book” a party room up to 1 week in advance of a party. Users may only set up parties equal to the number of available segments in their ‘My Events’ calendar in the virtual world, and the users party takes up time on that calendar so that a user cannot schedule two parties at once.

According to one embodiment, party room parties may only be held using KinzChat™, which is a chat system that requires users selected chat messages from a list of pre-scripted chat phrases, such as is described in more detail in U.S. Pat. No. 7,677,948. However, according to one embodiment, members with a Deluxe account (e.g. an account obtained by paying a premium) will get the option to upgrade their party room pack to KinzChat™ Plus when they drag and drop their party room pack into a pet's room. KinzChat™ Plus is a chat system that allows users to freely type chat messages that are filtered for inappropriate content, such as that described in U.S. Patent Application Publication No. 2009/0228557 to Ganz, the entire contents of which are incorporated by reference herein. When a non-deluxe user obtains a party pack, they get a message that says “All Party Room Packs are available in KinzChat™ ONLY however, if you have a Deluxe Webkinz® account, you will have the option to upgrade your Party Pack to KinzChat™ Plus!”

This encourages users to upgrade their accounts, in order to obtain the enhanced features available in KinzChat™ Plus. According to one embodiment, the system may display the message “CLICK HERE TO UPGRADE TO KINZ CHAT PLUS”, along with a button to upgrade!

The party may end after a predetermined period of time, for example 30 minutes. All guests and the host are automatically redirected back to their homes once the scheduled end of a party room party arrives in one embodiment. In another embodiment, rather than automatically redirecting to the guest's virtual home at the end of the party, the guests stay in a virtual room until the host decides to send all home or until the guests decide to leave.

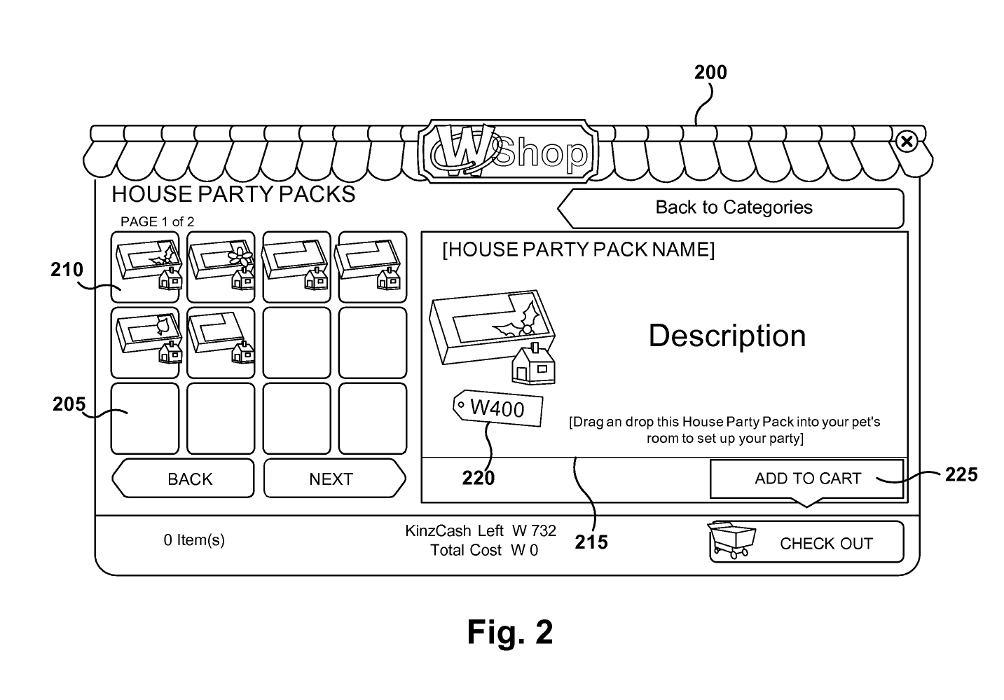

FIG. 1 shows the main WShop page 100, and how the new section 105 entitled party pack has been added to that page. Selecting the party packs option leads the user to the page shown in FIG. 2, which shows the house party pack and the different items that it includes. There can be different party packs shown generally as 205, with any party pack that is selected such as 210 having its details and descriptions shown as 215. The description may indicate the contents of the party pack and its price 220. The description may include items that are in the party pack, and also instructions on how to use those items. For example, that description may indicate that a user should drag and drop the house party pack into the user's pet's room to set up the party.

The user can select a party pack by adding it to the cart at 225.

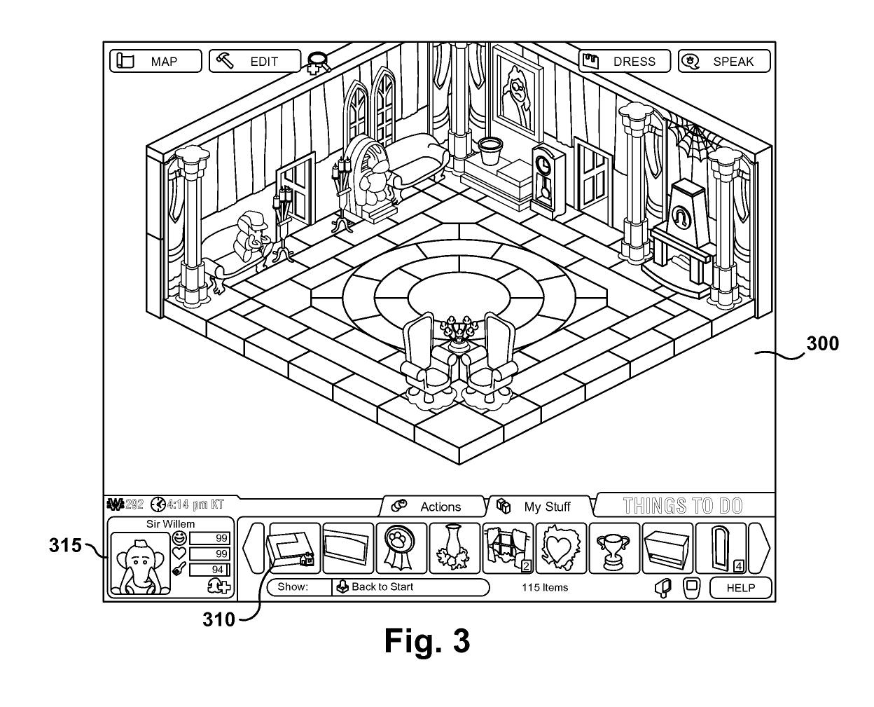

Once the user has purchased a party pack, when they return to their virtual room 300 as shown in FIG. 3, the party pack appears as 310 in the user's “dock” 315. This thereafter allows the user to use that party pack.

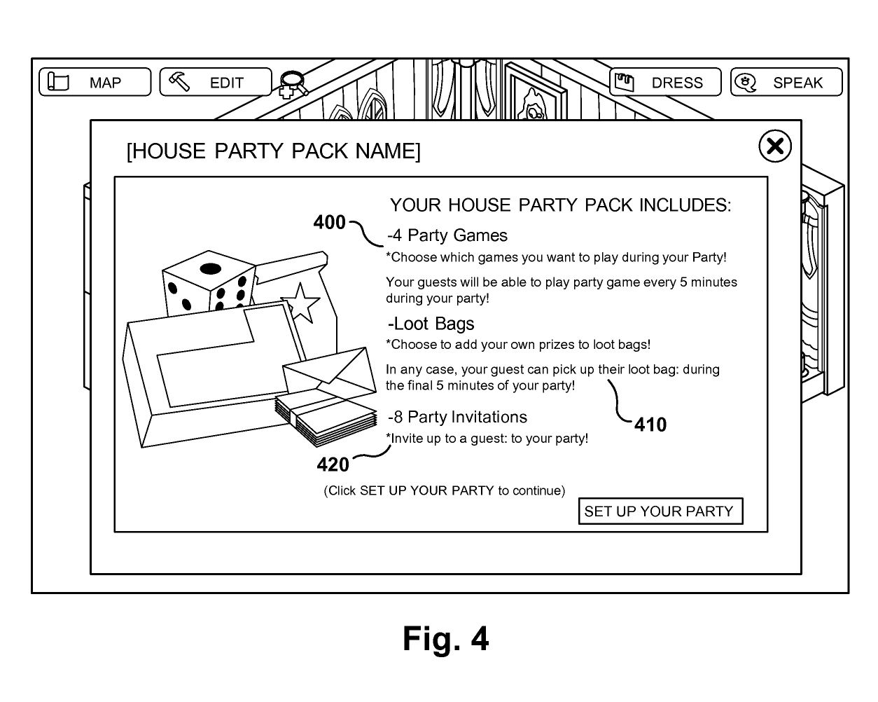

Selecting the party pack, e.g. by dragging it into the virtual room, brings up the screen shown in FIG. 4, showing the items in the party pack including an ability of 400 to choose different games, 410 to choose and configure loot bags which are given to the different participants in the party, and 420 to configure and send party invitations.

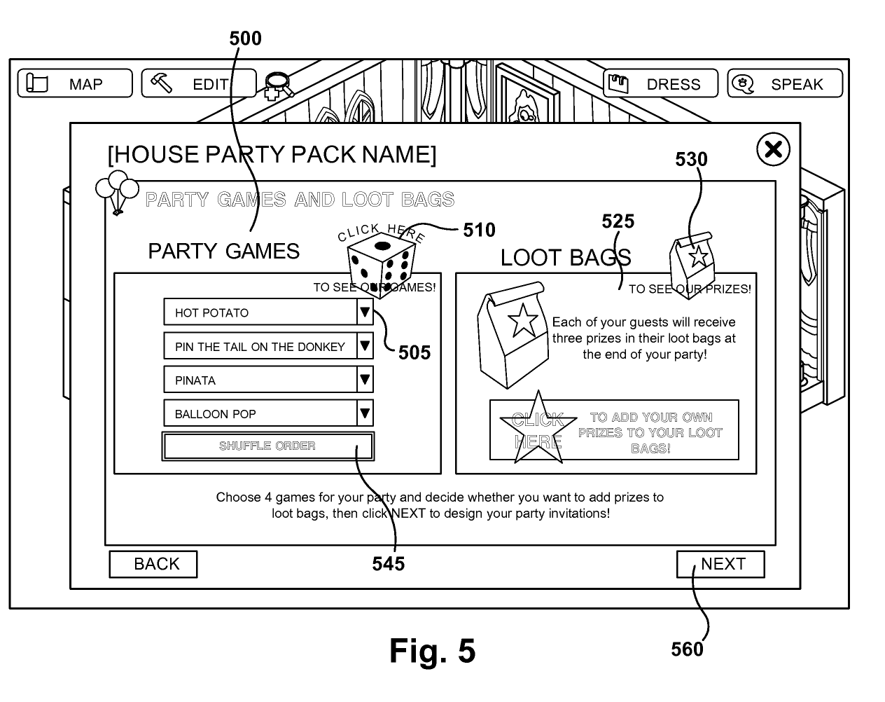

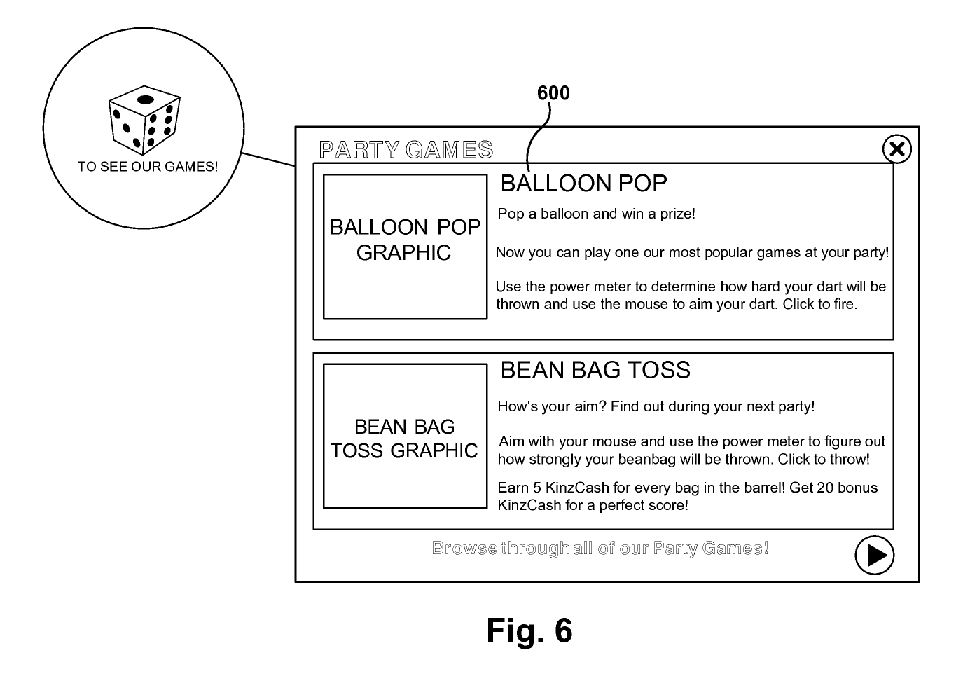

The user can set up the different items as shown in FIG. 5. For example, the party games screen 500 shows a number of different games that are selectable via drop down menus 505. That page also includes a link 510 that provides information regarding the party games. The information is as shown in FIG. 6 where any particular game that is chosen, such as “Balloon Pop”, has information such as 600 that describes how that game is played. The user can select any four games from the interactive drop-down menu.

Some example games are described below along with exemplary descriptions of how those games are played.

### “Hot Potato”

Example description: “Take turns passing a potato in this multiplayer game but don't get caught holding it when it explodes or you'll be eliminated! The last player left at the end of the game wins!”

### “Pin the Tail on the Donkey”

Example description: “Can you pin the tail on the dancing donkey? Find out by playing this multiplayer party game! Each player will get one chance to Pin the Tail on the Donkey. The player who is the closest wins!”

### “Pinata”

Example description: “Take turns hitting the piñata with a stick during this multiplayer party game! If you manage to break open the piñata, everyone wins a prize!”

### “Bean Bag Toss”

Example description: “How's your aim? Find out during your next party! Aim with your mouse and use the power meter to figure out how strong your beanbag will be thrown. Click to throw! Earn 5 KinzCash for every bag in the barrel! Get 20 bonus KinzCash for a perfect score!”

### “Balloon Pop”

Example description: “Pop a balloon and win a prize! Now you can play one of our most popular games at your party! Use the power meter to determine how hard your dart will be thrown and use the mouse to aim. Click to fire.”

### “Jellybean Count”

Example description: “Can you guess correctly? You have three tries to guess the number of jellybeans there are inside the candy jar. Guess correctly and you'll win a prize! Good luck!”

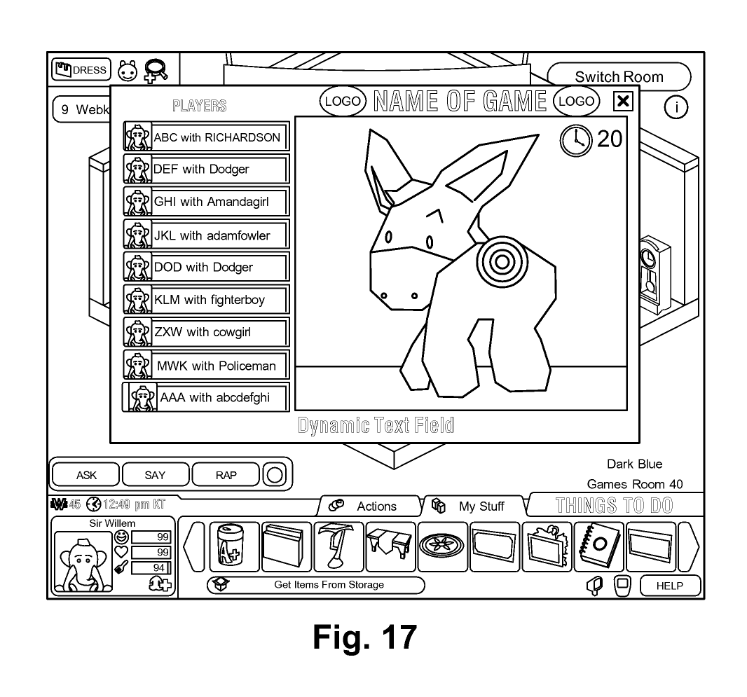

Using the selector 415, the user can also re-shuffle the order of those games. In one embodiment, when a game is played, all the party guests are automatically added to the game as shown in FIG. 17. In this way, all of the attendees are automatically entered into multiplayer games at a party.

In a similar way, the user can set the items that are put into the loot bags at 525 as shown in FIG. 5. The loot bags include items that the party attendees will receive at the end of the party, much like a real loot bag.

The user also obtains an information item 530 that can be selected to indicate the different things that can be put into the loot bag.

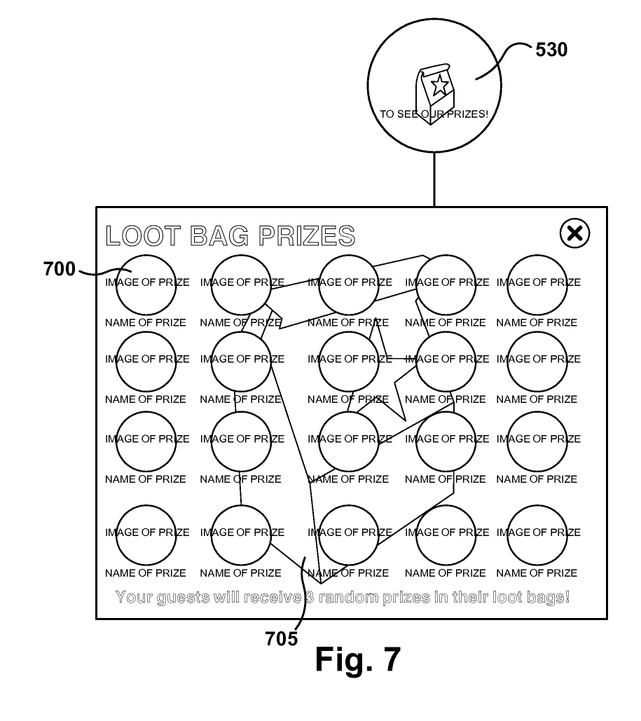

FIG. 7 illustrates how the loot bag prizes can be seen, where the name and image of each prize is shown as 700. Each loot bag can be preconfigured with certain items therein. The party organizer can also add their own prizes, e.g. prizes that they have accumulated from other sources, to their loot bag.

Note in FIG. 7 that the background image of the menu is itself a loot bag 705. After the user has configured the games in the loot bags, they select the “next” button at 550 to configure the next part of the party.

According to one embodiment, the system automatically ensures that loot bags are consistent, that all loot bags have approximately the same amount of rewards therein. However, different loot bags may have different rewards therein.

The loot bags are randomly distributed to the guests as described herein, based on the guest asking to “grab” the loot bag at or near the end of the party. Any added prizes that are not awarded to the guests are returned to the user's dock at the end of the party.

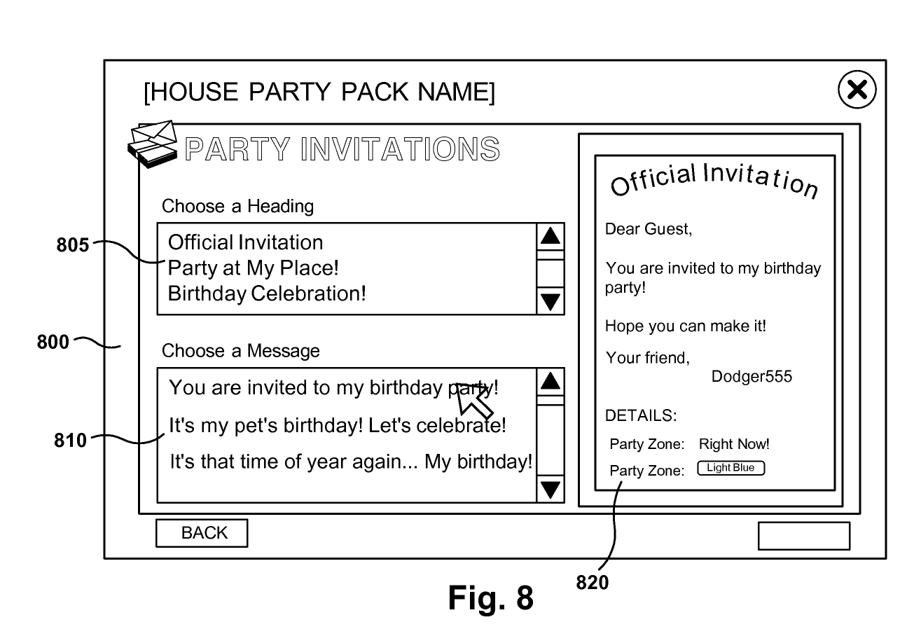

The party pack also has an official invitation shown in FIG. 8 as 800. The invitation allows the user to select different things from drop-down menus including selecting a heading at 805, such as invitation, party, birthday celebration or other information that may indicate the purpose of the party.

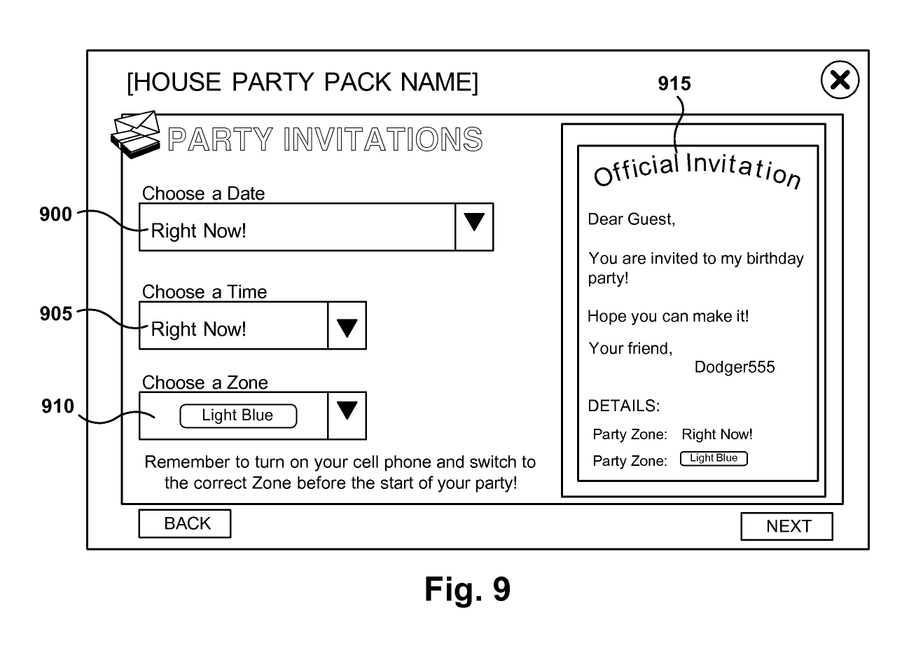

FIG. 9 illustrates other information about the party pack that can be added. The user chooses at date 900 and time 905 as well as a color zone for the party. One option for the date is “right now”. All of these are added to the invitation preview at 915.

In an embodiment, all parties are scheduled to last 30 minutes. Users have the option to set up a party “Right Now”, as opposed to scheduling some future date and time. In one embodiment, “Right Now” may be set as the default setting for the drop down menus 900 and 905. Other than “right now”, users can choose to schedule a party from 8 am to 11 pm on the hour or half hour.

Party start times within the drop down menu 905 of invitations in party room packs have two states: “Active” and “Inactive”. If the system determines that a time slot is fully “booked”, the start time related to that time slot is “inactive” and grayed out (that is, users will not be able to double book a party room). Additionally, if the current date is selected from the date drop down menu 900, the time slots earlier than the current time of day will also be “inactive” and grayed out.

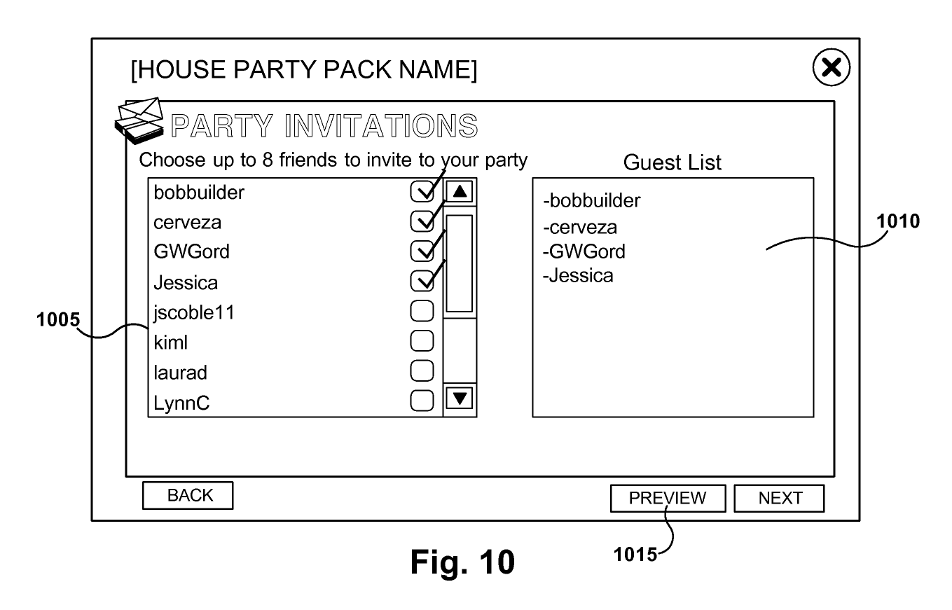

FIG. 10 illustrates the user being able to choose friends to add to the party. A version of a user's friends list is featured at 1005, with the user being able to select any of these friends. Each of the names within the user's friends list have two states: “Active” and “Inactive”. Check boxes are featured next to each name within the user's friends list. Clicking a check box causes a check mark to appear within the box. A name that has been “checked” must appear within a user's “Guest List” 1010. The guest list displays the names of friends a host has invited to a party. Clicking on a name within a user's friends list will automatically add the friend's name to a user's Guest List. Clicking on the “Preview” button 1015 will trigger a preview of the invitation 915 (see FIG. 9) as a pop up over a user's guest list 1010.

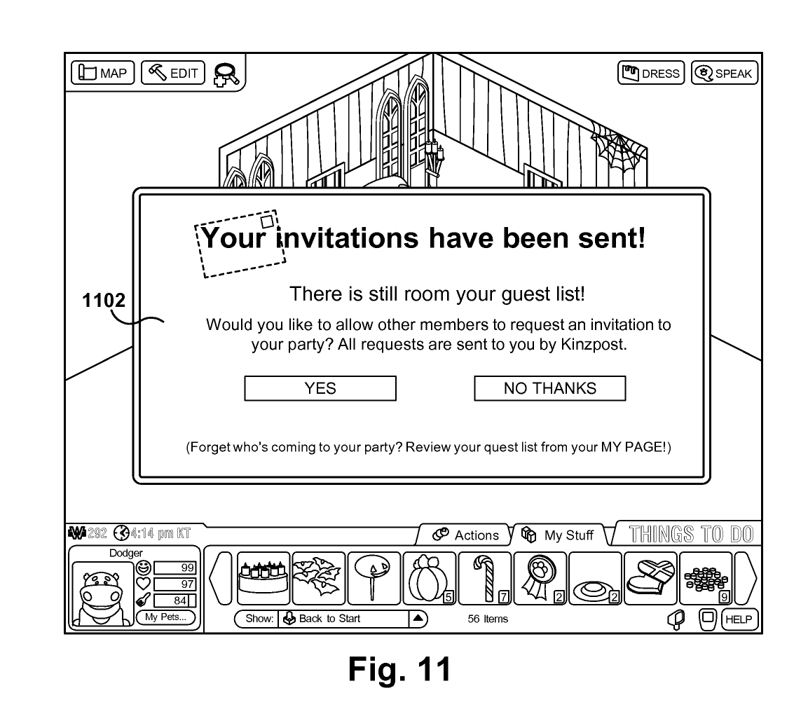

Once the party invitations have been sent (the user clicks the “Send” button 1020 in FIG. 10), the user sees the confirmation screen 1100 shown in FIG. 11. If the user still has room to send additional invitations or invite additional people, the copy shown on the confirmation screen 1100 tells the user that. Including the one shown, there are three versions of copy that can be used with the confirmation screen 1100.

The following example copy is triggered if a user invites eight guests to their party: “Your guest list is full! Would you like to allow other members to request an invitation to your party if one or more of your guests declines an invitation? All requests are sent to you by KinzPost.”

As shown in the confirmation screen 1100 of FIG. 11, the following example copy is triggered if a user invites fewer than eight guests to their party: “There is still room on your guest list! Would you like to allow other members to request an invitation to your party? All requests are sent to you by KinzPost.”

The following example copy is triggered if a user sends out party invitations for a party that is scheduled to begin “Right Now”: “Your invitations have been sent.” An “OK” button replaces “YES” and “NO THANKS” buttons shown in FIG. 11.

The parties can have different purposes or themes that can be selected by the user, including, for example:

### Fixed House Party Packs:

“Birthday Girl Party”
“Birthday Boy Party”
“Tea Party”
“Pizza Party”
“Garden Party”

### Seasonal House Party Packs:

“Halloween Party”
“Christmas Party”
“Valentine's Day Party”
“Spring Fling Party”
“Summer Fun Party”
“Winter Party”
   In one embodiment, seasonal parties will be rotated throughout the year. The Seasonal Party Pack may be the first Party Pack featured within the WShop and acts as the default Party Pack.

Some example themes and example invitation messages and designs corresponding to each are listed below:

### Birthday Girl Party (Party Room Pack)

“Official Invitation”
“Let's Celebrate!”
“I'm Hosting a Party Room Party!”
“It's my pet's birthday! Let's celebrate!”
“You are invited to my birthday party!”
“I'm hosting a birthday party and you're invited!”
Flower design
Persephone design
Birthday cake design

### Birthday Boy Party (Party Room Pack)

“Official Invitation”
“Let's Celebrate!”
“I'm Hosting a Party Room Party!”
“It's my pet's birthday! Let's celebrate!”
“I'm hosting a birthday party and you're invited!”
“It's my birthday! Let's Party!”
Puppy Patrol design
Sports design
Webkinz® Rally design

### Enchanted Party (Party Room Pack)

“Let the Magic Begin!”
“Let's have a Party!”
“Do you believe?”
“Let's celebrate the magic of Webkinz!”
“I'm having a magical party. Please feel free to dress up!”
“Please come to my Enchanted Party!”
Magical Forest design
Pink Unicorn
Dragon design

### Big Top Party (Party Room Pack)

“The Circus has Arrived!”
“Time for the Big Top!”
“I'm Hosting a Circus Party!”
“You are invited to my circus themed party!”
“Stop clowning around and come to my Big Top Party!”
“I'm hosting a costume party and you're invited!”
Clown design
Circus elephant design
Circus stripes design

### Blockbuster Party (Party Room Pack)

“Lights, Camera, ACTION!”
“Let's party like the stars!”
“Ready for your close up?”
“Do you love the movies? Me too! Let's party!”
“Time for your red carpet appearance!”
“Come hang out with my friends at my Blockbuster party!”
Popcorn design (bag of pop corn design)
Various size star design
Movie film design

### Halloween Party (Party Room Pack)

“Halloween Party!”
“BOO!”
“Official Invitation”
“Feel free to dress up in your favorite costume!”
“Don't be scared! This is only a party invitation!”
“Let's celebrate Halloween! (It only comes once a year!)”
Jack-O-Lantern design (featuring various carvings)
Candy design (Webkinz® Candy)
Spooky Ghost design

### Christmas Party (Party Room Pack)

“Christmas is Here!”
“It's That Time of the Year!”
“I'm Hosting a Party Room Party!”
“You are invited to my Christmas Party! (Wear something warm!)”
“I'm hosting a Christmas party and you're invited!”
“Celebrate the holidays with me!”
Gingerbread cookie design (gingerbread pets)
Christmas lights design
SantaKinz design

### Valentine's Day Party (Party Room Pack)

“Official Invitation”
“Do you LOVE to party?”
“I'm hosting a Valentine's party!”
“I would love for you to come to my Valentine's Day Party!”
“Celebrate Valentine's Day at my Party Room Party!”
“Stop in for some fun and games!”
Heart shaped chocolate design
Red, and pink heart design.
Roses design

### Spring Celebration Party (Party Room Pack)

“Winter is over! Let's celebrate!”
“Official Invitation”
“Spring is here!”
“Let's celebrate the end of winter with a Party Room Party!”
“You are invited to my Spring Celebration Party!”
“Come and celebrate the best season ever: Spring!”
Easter egg design
Flower design
Bunny design

### Beach Party (Party Room Pack)

“Official Invitation”
“Let's Celebrate!”
“I'm Hosting a Party Room Party!”
“It's summer! Come celebrate at my party!”
“Summer's here! Time to party!”
“Love summer as much as I do? Let's celebrate!”
Sunglasses, beach ball and fancy drink design
Beach and palm tree design
Sea shell and starfish design

### Winterfest Party (Party Room Pack)

“Winter Rocks!”
“Let's Celebrate!”
“Let it Snow!”
“What's better than winter? A WINTER PARTY!”
“Come celebrate winter at my Party Room Party!”
Winter is here! Let's celebrate!”
Snowflake design
Pets skating on a frozen pond design
Winter hat and mittens design

### House Party Parties

### Birthday Girl Party (House Party Pack)

“Official Invitation”
“Let's Celebrate!”
“I'm Hosting a Party Room Party!”
“It's my pet's birthday! Let's celebrate!”
“You are invited to my birthday party!”
“I'm hosting a birthday party and you're invited!”—Flower design
Persephone design
Birthday cake design

### Birthday Boy Party (House Party Pack)

“Official Invitation”
“Let's Celebrate!”
“I'm Hosting a Party Room Party!”
“It's my pet's birthday! Let's celebrate!”
“I'm hosting a birthday party and you're invited!”
“It's my birthday! Let's Party!”
Puppy Patrol design
Sports design
Webkinz® Rally design

### Garden Party (House Party Pack)

“Come out and Play!”
“I'm hosting a Garden Party!”
“Official Invitation!”
“Come on out for some fun in the sun!”
“I have designed a new garden! Come on over and check it out!”
I'm hosting a Garden Party and you're invited!”
Butterfly design
Flower design
Picnic design

### Tea Party (House Party Pack)

“Tea Time!”
“I'm Hosting a Tea Party!”
“Do you love Tea as much as me?”
“Let's chat at my Tea Party!”
“You are invited to my Tea Party! Party food will be served!”
“Dress your best for a Tea Party hosted by ME!”
Tea cup and saucer design
Teapot design
Sugar cube and sugar bowl design

### Pizza Party (House Party Pack)

“Yeah Pizza!”
“I'm Hosting a Pizza Party”
“Who loves pizza?”
“You are invited to my place for a Pizza Party!”
“Pizza will be served . . . need I say more?”
“Dude! I'm hosting a Pizza Party!”
Pizza slice design
Chef Gazpacho design (Chef Gazpacho looks like he is making a pizza)
A pet eating a cheese pizza design (cheese string between pet's mouth and pizza—triple cheese pizza).

### Halloween Party (House Party Pack)

“Halloween Party!”
“BOO!”
“Official Invitation”
“Feel free to dress up in your favorite costume!”
“Don't be scared! This is only a party invitation!”
“Let's celebrate Halloween! (It only comes once a year!)”
Jack-O-Lantern design (featuring various carvings)
Candy design (Webkinz® Candy)
Spooky Ghost design

### Christmas Party (House Party Pack)

“Christmas is Here!”
“It's That Time of the Year!”
“I'm Hosting a Party Room Party!”
“You are invited to my Christmas Party! (Wear something warm!)”
“I'm hosting a Christmas party and you're invited!”
“Celebrate the holidays with me!”
Gingerbread cookie design (gingerbread pets)
Christmas lights design
SantaKinz design

### Valentine's Day Party (House Party Pack)

“Official Invitation”
“Do you LOVE to party?”
“I'm hosting a Valentine's party!”
“I would love for you to come to my Valentine's Day Party!”
“Celebrate Valentine's Day at my House Party!”
“Stop in for some fun and games!”
Heart shaped chocolate design
Red, and pink heart design.
Roses design

### Spring Fling Party (House Party Pack)

“Winter is over! Let's celebrate!”
“Official Invitation”
“Spring is here!”
“Let's celebrate the end of winter with a House Party!”
“You are invited to my Spring Celebration Party!”
“Come and celebrate the best season ever: Spring!”
Easter egg design
Flower design
Bunny design

### Summer Fun Party (House Party Pack)

“Summer is here!”
“Let's Celebrate!”
“I'm Hosting a Party at My Place!”
“It's summer! Come celebrate at my party!”
“Summer's here! Time to party!”
“Love summer as much as I do? Let's celebrate!”
Sunglasses, beach ball and fancy drink design
Shining sun design featuring Webkinz® playing beach volleyball
Fancy drink design

### Winter Fun Party (House Party Pack)

“Winter Rocks!”
“Let's Celebrate!”
“Let it Snow!”
“What's better than winter? A WINTER PARTY!”
“Come celebrate winter at my Party Room Party!”
Winter is here! Let's celebrate!”
Snowflake design
Pets skating on a frozen pond design
Winter hat and mittens design

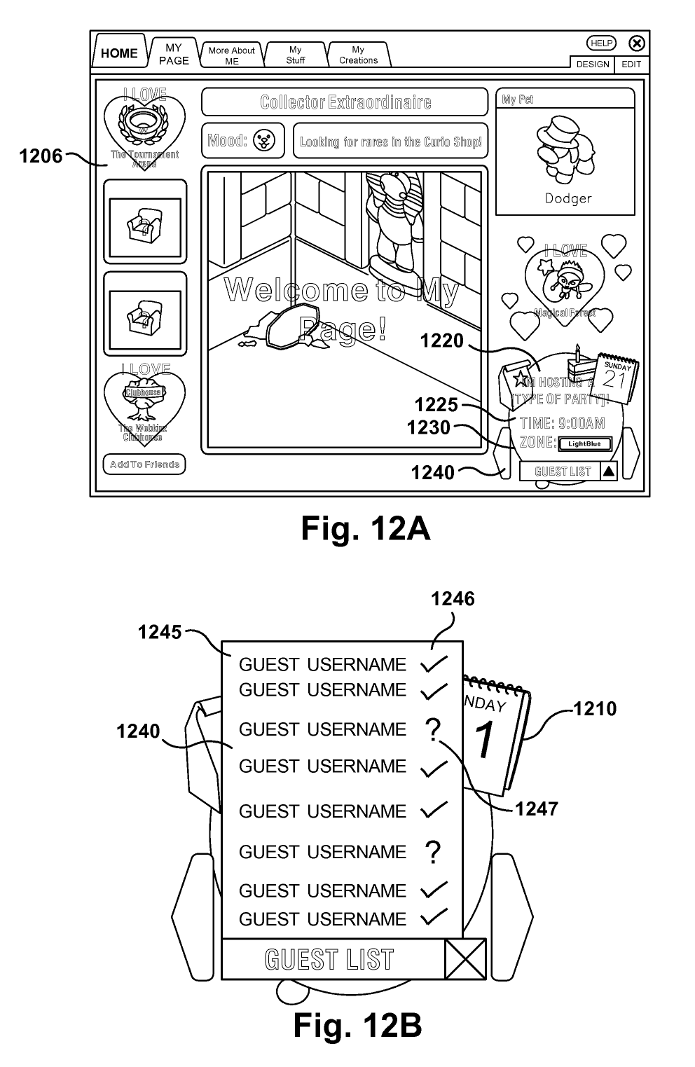

Once people have been invited, a party “widget” appears on the host's home page shown in FIG. 12. The home page 1200 appears with a party widget 1210 that shows the type of party 1220, times 1225, color zone 1230, as well as showing a drop-down guest list at 1240. The guest list 1240 shows each of a number of different guest usernames 1245, with check marks 1246 for those who have accepted and question marks 1247 for those who have not accepted. When an invitee declines in invitation, their name is removed from the list, thereby providing additional slots that the user can use to invite others.

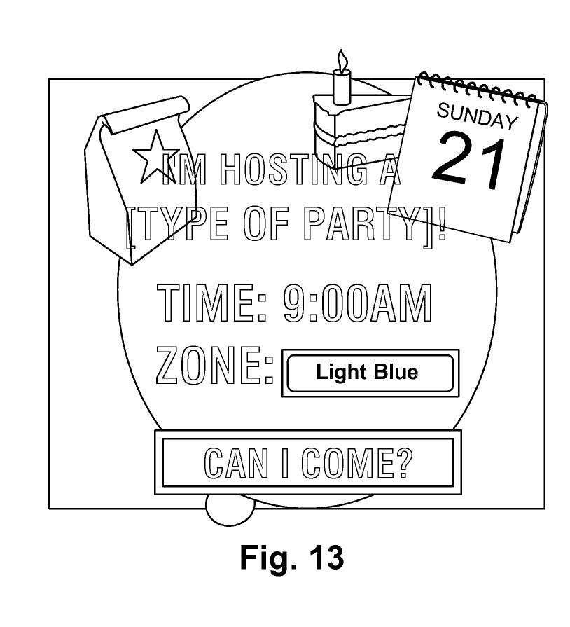

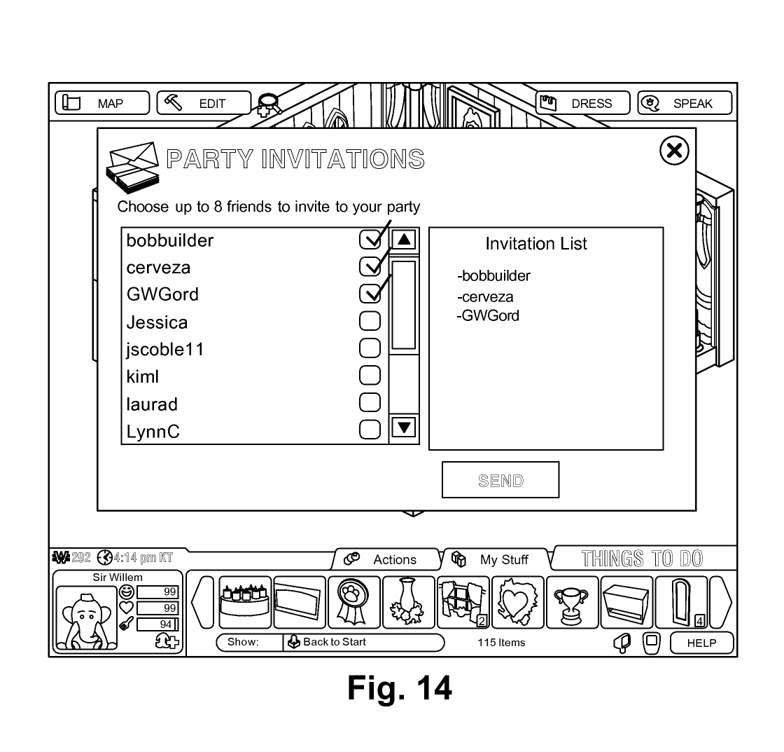

Users, e.g., friends who see the party, can also invite themselves to the host's party from the widget 1210. If the user for example still has room, then the widget 1210 is as shown in FIG. 13 where users can ask if they can come to the host's party. Also, FIG. 14 shows how if one user for example declines the invitation, the user having the party can choose other people from their friends list to invite. Those who have either accepted or declined are shown as inactive within the friends list of FIG. 14.

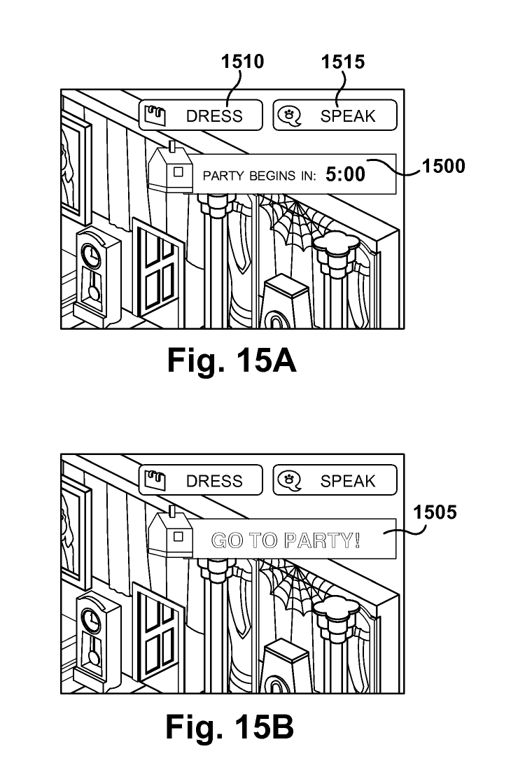

A party countdown may also be shown as shown in FIGS. 15A and 15B. For example, both the host and the guests who have accepted see the countdown clock 1500 before the party has started.

Five minutes before the party starts, the countdown clock 1500 changes, as shown in FIG. 15B, to a link 1505 that, when selected, transports the user to the party.

The users also get the ability via the “dress” button 1510 to dress for the party and via “speak” button 1515 to ask questions about the party or otherwise chat with the party owner.

A unique party food item can be designed for each party room. Each party food item can be divided, for example, into nine portions. The host and each guest at a party room party can “take” a portion of the party food by clicking on it.

Party food items are built into the party room design and have three states: “full”, “half” and “finished”. A piece of party food is awarded to a user's Dock by the user clicking on the party food at a party

If a user decides to feed their virtual pet a portion of party food (by dragging food item from their dock onto a pet's portrait) they will randomly trigger one of the following pet portrait tips:
“Yummy! I love parties!”
“Party on!”
“This is an awesome party!”
“That was awesome!”
“I love party treats!”

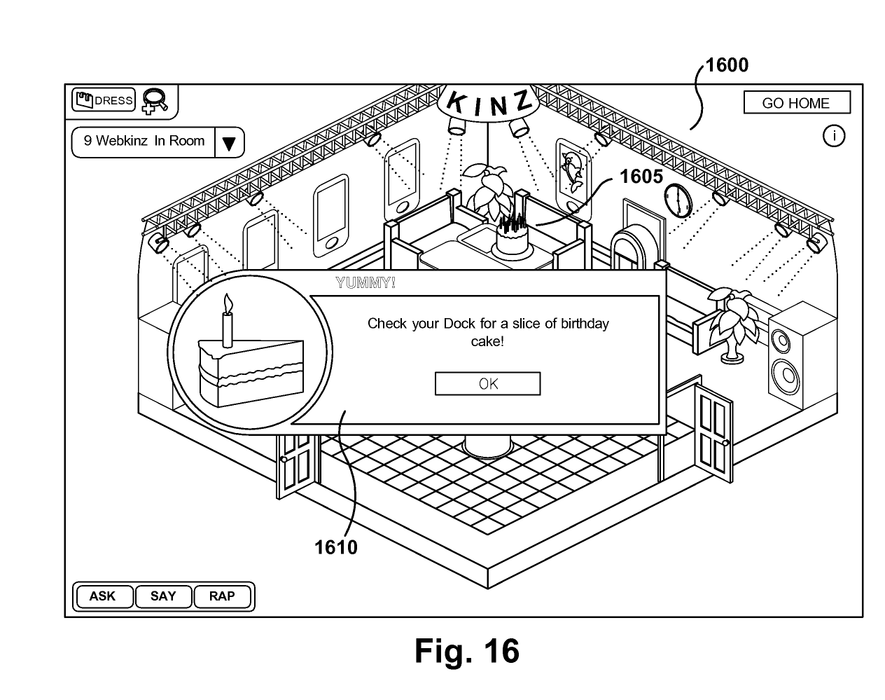

When a party food item is in its “full” state, the graphic of the food that appears within a party room appear “full” or “untouched” (the complete cake 1605 as shown in FIG. 16 for example).

When a party food item is in its “half eaten” state, the graphic of the food that appears within a party room appears “half eaten”. The “half eaten” state may be triggered, for example, after the fourth guest “takes” a portion of party food.

When a party food is in its “finished” state, the graphic of the food that appears within the party food buffet interface appears “completely eaten”. The “finished” state is triggered, for example, after the ninth party attendee “takes” a portion of party food. The following are examples of kinds of foods and states can be used.

For a girl birthday party, there can be a large white, pink and red cake that is in the shape of a strawberry, garnished with strawberry slices and thick icing, and featuring birthday candles. The states and other details for the party food are, for example:

FULL STATE: A strawberry shaped cheesecake featuring five burning candles.
HALF STATE: Featuring three extinguished candles, half a cake and crumbs.
FINISHED STATE: Empty plate with crumbs and a serving knife
PORTION: Piece of cake with candle

### PORTION NAME: “Piece of Strawberry Cheesecake”

For a birthday boy party, the party pack can include a black forest cake, which is a classic black forest cake featuring five burning candles, served on a large plate. The states and other details for the party food are, for example:

FULL STATE: Featuring five burning candles.
HALF STATE: Featuring three extinguished candles, half a cake and crumbs.
FINISHED STATE: Empty plate with crumbs and a serving knife
PORTION: Piece of cake with candle

### PORTION NAME: “Piece of Black Forest Cake”

For an enchanted party, the states and other details for the party food are, for example:

Moonberry Magic Cake—A cake made out of Moonberries (as seen within Jumbleberry Fields). Moonberries have been carefully placed on this cake to make it look like a starry night sky with a moon (think of Van Gogh's Starry Night).
FULL STATE: Full cake
HALF STATE: Featuring half a cake and crumbs.
FINISHED STATE: Empty plate with crumbs and a serving knife
PORTION: Piece of cake

### PORTION NAME: “Piece of Moonberry Magic Cake”

For a big top party, the states and other details for the party food are, for example:

Clown Cake A cake that looks like a circus clown (served in a cake tin mold)
FULL STATE: Cake is in a hollow tin that is textured/shaped to look like a clown.
HALF STATE: Featuring half a cake and crumbs.
FINISHED STATE: Empty cake mold and crumbs.
PORTION: Piece of cake

### PORTION NAME: “Piece of Clown Cake”

For a blockbuster party, the states and other details for the party food are, for example:

Popcorn Machine—A movie theatre popcorn machine, filled with popcorn, sitting on a counter. Movie theatre themed popcorn bags can be seen hanging from the side of the machine.
FULL STATE: Full popcorn machine.
HALF STATE: Half full popcorn machine
FINISHED STATE: Empty popcorn machine.

### PORTION: (Bag of Popcorn)

(Portion of food is a movie theatre themed popcorn bag—user drag and drop a full bag of popcorn from the popcorn machine to their pet's portrait)

### PORTION NAME: “Bag of Popcorn”

For a halloween party, the states and other details for the party food are, for example:

Creepy Cookies A tray of Halloween themed cookies (Cookies are shaped and decorated to look like ghosts). This is a presentable item in this state.
FULL STATE: Full tray of cookies
HALF STATE: Half tray of cookies
FINISHED STATE: Empty tray of cookies

### PORTION: 1 Cookie

### PORTION NAME: “Creepy Cookie”

For a Christmas party, the states and other details for the party food are, for example:

Egg Nog—A large bowl of eggnog sitting on a glass serving buffet. A stack of plastic glasses sit next to the bowl. Bowl is Christmas themed.
FULL STATE: A full bowl of egg nog with a full stack of plastic cups.
HALF STATE: Half full bowl of egg nog with half a stack of cups.
FINISHED STATE: Empty bowl of egg nog with no more plastic cups (one or two “used” cups could be turned on their side on top of table).
PORTION: 1 glass of egg nog
PORTION NAME: “Glass of Egg nog”

For a Valentine's Day party, the states and other details for the party food are, for example:

Box of Chocolates—A heart shaped box of chocolates, served on what looks like a side table made out of chocolate.
FULL STATE: Full box of chocolates
HALF STATE: Half box of chocolates. A few have scattered onto the serving table.
FINISHED STATE: Empty box of chocolates
PORTION: One heart shaped chocolate

### PORTION NAME: Piece of Chocolate

For a Spring celebration party, the states and other details for the party food are, for example:

Chocolate Covered Carrots—A platter featuring chocolate covered carrots (that have only been half dipped in carrots). Flowers are arranged nicely on this serving table)

FULL STATE: Full tray of carrots
HALF STATE: Half tray of carrots
FINISHED STATE: Empty tray of carrots.
PORTION: 1 chocolate covered carrot.

### PORTION NAME: “Chocolate Covered Carrot”

For a beach party, the states and other details for the party food are, for example:

Ice Cream Machine—A large, elaborate machine that is used to make ice cream cones. There is a light on the machine that blinks when placed in a pet's room.

FULL STATE: A clean machine.
HALF STATE: Machine is starting to look dirty (covered in ice cream)
FINISHED STATE: Machine is covered in splotches of ice cream.
PORTION: 1 summer themed ice cream cone (Garnished with mini chocolate sunglasses)

### PORTION NAME: “Party Ice Cream Cone”

For winterfest party, the states and other details for the party food are, for example:

Snow Cone Machine—A large, elaborate machine that is used to make snow cones. There is a light on the machine that blinks when placed in a pet's room. A stack of snow cone “cups” are featured next to the machine. The machine features winter themed buttons and designs.
FULL STATE: A clean machine will full stack of cups.
HALF STATE: Machine is starting too look dirty (covered in ice) and half stack of cups remain.
FINISHED STATE: Machine is covered in splotches of ice. No more cups remain.
PORTION: 1 summer themed ice cream cone (Garnished with mini chocolate sunglasses)

### PORTION NAME: “Party Snow Cone”

The following are examples of prizes that can be provided in loot bags:
Party Pop—A can of pop featuring a colorful balloon design. This a food item (can be fed to pet)
Party Banner—A banner featuring party themed graphics (balloons, steamers and cake).
Party Place Setting—A plastic clown themed place setting, clown themed paper plate and paper cup. A plastic fork and knife sit on either side of the place setting. Some colorful confetti is “sprinkled” on top of place setting (two “place settings” per item—refer to other Webkinz® place setting). This is a presentable item.
Balloon—A large balloon shaped like a Zum (should hover slightly when placed in a room).
Party Cap—A colorful party hat (pattern must be very different from the party hat featured within WShop).
Jumbo Sunglasses—Large over sized pink sunglasses that can be worn by a pet.
Dunce Cap—A cone shaped party hat (could feature Kinzville Academy colors).
Banquet Burger—A large “All dressed” burger with bacon and cheese. This is presented on the same paper plate as the plate featured within the “Party Place Setting” loot bag item. This is a food item (can be fed to pet).
Clown Car—Vehicle with functionality. This colorful car should be smaller than regular Webkinz® vehicles so that the pet looks quite awkward “driving” this item.
Party Poster—A picture of a Webkinz® pet blowing out the candles on a birthday cake. This item can be hung on a pet's wall.
Dancing Shoes—These shoes are light purple and shimmer slightly (animated effect—similar to Dorothy's Ruby Slippers). These shoes are women's high heel shoes.
Confetti Cannon—This cannon is a one tile object and “sits” on a small stand. Clicking on this item sends confetti flying across the room.
Party Welcome Mat—This colorful welcome mat features party themed graphics. “Party Time!” is printed on the mat.
Sparkler—Click to turn sparkler “on” and “off”. Looks like a candle and can be placed on tables and pedestals.
Chocolate Zingoz™—A chocolate Zingoz™ that comes in a box (Easter bunny box). The box has clear front and Zingoz™ can be seen through front. The border of the box features a party balloon design.
Festive Fruit Punch—A pink fruit punch served in an elegant, fun looking tall punch glass. Confetti can be seen in front of glass and straws are in glass. A stir stick featuring balloon is featured in glass. Glass is garnished with slices of fruit.
Magic W Face Sticker—A clothing item that fits in the “Glasses” slot within the “dress your pet” interface. Putting this sticker on a pet makes it look like the pet has a Magic W tattoo on its face.
Party Popsicle—A colorful popsicle that is half exposed (wrapper is covering bottom half of popsicle). An image of a clown holding balloons is featured on the popsicle wrapper.
Funky Face Paint—Looks like clown face paint (similar to Zombie Face Paint Functionality). Can be worn by pet.
Gummy Balloons—A hand full of colorful gummy candies that are designed to look like individual balloons.
There can also be Party Badges that are awarded, which can be displayed on the user's social networking page. For example:
“Host With The Most” badge—Can be awarded to a user that purchases their 10th Party Pack from the WShop (House Party Pack OR Party Room Pack). Party balloons are featured on this badge.
Party Animal—Awarded when user “grabs” their 15th loot bag. The image of a party loot bag is featured on this badge.
Monster Bash—Awarded when a user purchases a Halloween Party Pack (KinzChat™ or KinzChat™ Plus). The image of a “Creepy Cookie” (portion of Halloween Party Food) is featured on this badge.
Party Pooper—The first time a user declines a party invitation. An image of a deflated balloon is featured on this badge.

When the prizes in a loot bag are food, the party food automatically appears as 1605 within the party room 1600 (as shown in FIG. 16). The user can click on the party food, to automatically receive an item of the party food in their dock. The user then receives a message at 1610 indicating that the party food has been added to their dock.

A link becomes available during the last five minutes of a party (following last party game) allowing users to claim their loot bags. If a user selects a loot bag link, a loot bag is added to their dock. Note that loot bags have the same functionality as the “Packed Lunch” that users receive for completing Recess. If users drag and drop a loot bag into a pet's room, a “bursting star” effect is triggered and a special system message is triggered showing the contents of the loot bag (the names and images of the three loot bag prizes awarded to user appear in the system message). Optionally, a timer could appear within the “Grab A Loot Bag” button, making it clear as to how long users have to claim their loot bags. There can be two different kinds of loot bags for the user to choose from, each with its own extra prize or prizes.

If a user receives a loot bag WITHOUT an extra added prize, the system message triggered by dragging and dropping the loot bag into a pet's room should feature the names and images of the three prizes won by the user.

If a user receives a loot bag WITH an extra added prize, the system message triggered by dragging and dropping the loot bag into a pet's room should feature the names and images of the three prizes won by the user PLUS the name and image of the extra prize added by the host of the party.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example as described above, other holidays can be celebrated in a similar way, other kinds of parties can be planned in this way, and each party can have some different number of users than those previously described.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may be a server computer that sends information to multiple different client computers, or can be a client computer that interacts with a server computer, or can be a stand-alone computer operating based on stored instructions. The computer can include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media, e.g., a non-transitory medium, used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
selling to a first user, on an electronic store hosted by a server computer system, a virtual party package, which has multiple items therein, said virtual party package including all of party favors to be given to party guest users, multiplayer games to be played by the party guest users, food for the virtual party to be consumed by party guest users, and an invitation template routine, operative for inviting a specified number of party guest users to the virtual party;
responsive to said selling said virtual party package, adding all of said multiple items as a single package to a user's inventory of items maintained by said server computer system, where said inventory of items includes other virtual items owned by the user prior to said virtual party package being added;
responsive to receiving a selection of said virtual party package from said inventory of items, the server computer system providing a user interface which controls, via a user interaction, selecting each of a plurality of games to be played during a party, each of the plurality of games being selectable from one of a plurality of different games, which controls the user selecting items to be given to party attendees as gifts for attending the party, where said items to be given to said party attendees are selected from a number of items, and which controls a template for inviting party attendees, including a form for said inviting, and selection of party guest users to attend the virtual party.

2. A method as in claim 1, wherein said user interface allows the user to select n party guest users to attend the virtual party, and wherein the server computer system informs the first user when they have not invited all of the possible n party guest users.

3. A method as in claim 2, further comprising the server computer system maintaining a count of a number of party guest users who have accepted and have declined an invitation to the party, and further comprising informing the first user that they can invite other party guest users responsive to invitees having declined.

4. A method as in claim 1, wherein said purchasing comprises purchasing by said first user, one option of a number of different options for parties, wherein said different options include packages with different party formats.

5. A method as in claim 4, wherein said one option is a house party pack that allows the first user to create said virtual party within an existing virtual room owned by the user within an existing virtual world, and wherein the first user must be present in order for the party to occur.

6. A method as in claim 4, wherein said one option is a party room pack that allows the first user to create said virtual party within a party room that is not owned by the first user, where said party room is part of the party room pack, and where the virtual party can occur without the first user being present within the party room.

7. A method as in claim 1, wherein said user interface controls selection of a date and time at which the party will occur.

8. A method as in claim 7, further comprising a countdown timer, associated with the user interface that will be seen by at least one user, wherein said countdown timer counts down to the time of the party until a predetermined time before the time of the party, and at said predetermined time before the time of the party, changes to a link that can transport users to a virtual room hosting the party.

9. A method as in claim 1, wherein said games are multi-player games, and where all party participants are automatically added to said multiplayer games.

10. A method as in claim 1, further comprising displaying the food during the party, wherein users at the party can take pieces of the food, and wherein the food has different display states, including a first display state for food that has not been eaten, a partial display state for food that has been partially eaten, and an empty state for food that has been completely eaten.

11. A method comprising:
hosting, on a server computer system, a virtual world with virtual objects, including registering a virtual character by a host user,
selling, via the server computer system, a package to the host user allowing the host user to invite a plurality of guests to an event in a virtual room for a limited time period with an incentive of allowing the plurality of guests to participate in multiplayer games and providing virtual items to each of the plurality of guests,
providing, by the server computer system, an application for the host user to select virtual items to be distributed to the plurality of guests randomly as gifts in exchange for attending the event,
where the virtual room is not owned by the host user, and where the party still occurs even when the host user is not present in said virtual room.
